(19) United States
(12) Patent Application Publication
(10) Pub. No.: US 2025/0371980 A1
(43) Pub. Date: Dec. 4, 2025

(54) UTILIZING DETERMINED STATUS IN DISPLAYING GRAPHIC OVERLAYS FOR NOTAMS

(71) Applicant: The Boeing Company, Arlington, VA (US)

(72) Inventor: Sheila Zapatero Bozal, Frankfurt (DE)

(21) Appl. No.: 18/733,655

(22) Filed: Jun. 4, 2024

(51) Int. Cl. G08G 5/00

(52) U.S. Cl. CPC G08G 5/21; G01C 21/3878; G08G 5/23; G08G 5/55; G08G 5/59; G01D 2207/10

(57) ABSTRACT

One example provides a computing device comprising a display device, a logic subsystem, and a memory subsystem. The memory subsystem comprises instructions that are executable by the logic subsystem to display a graphical airspace representing an airspace on the display device, and obtain one or more notice to air missions (NOTAMs) related to the airspace. The instructions are further executable to, for each NOTAM of the one or more NOTAMs, display a graphic overlay on the graphical airspace. The graphic overlay has an appearance based at least upon a determined status of the NOTAM.

### FIELD

The disclosed examples relate to graphically depicting Notice to Air Missions (NOTAMs) on a computing device display.

### BACKGROUND

NOTAMs are text publications that alert pilots of aviation operation information, such as the status of a facility, service, procedure, or the presence of potential hazards. In some instances, pilots and flight dispatchers review large numbers of such complex NOTAMs to plan and operate a flight.

### SUMMARY

One example provides a computing device comprising a display device, a logic subsystem, and a memory subsystem. The memory subsystem comprises instructions that are executable by the logic subsystem to display a graphical airspace representing an airspace on the display device, and obtain one or more notice to air missions (NOTAMs) related to the airspace. The instructions are further executable to, for each NOTAM of the one or more NOTAMs, display a graphic overlay on the graphical airspace. The graphic overlay has an appearance based at least upon a determined status of the NOTAM.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically illustrates an example aeronautical chart.

FIG. 2 schematically shows an example NOTAM.

FIG. 3 shows a block diagram of an example computing device for determining status of a NOTAM.

FIGS. 4A and 4B schematically illustrate example graphic overlays for an official NOTAM.

FIGS. 5A and 5B schematically illustrate example graphic overlays for a company NOTAM.

FIG. 6 shows a flowchart of an example method for determining a status of a NOTAM.

FIG. 7 shows a flow diagram of another example method for displaying a graphic overlay utilizing a determined status of a NOTAM.

FIG. 8 shows a block diagram of an example computing system.

### DETAILED DESCRIPTION

As previously mentioned, Notice to Air Missions (NOTAMs) are text publications that alert users (e.g., pilots, flight dispatchers, etc.) of information relevant to aviation operations. These NOTAMs include various information, such as classification codes, geographic tags, date stamps, and/or time stamps. This information can also include specialized abbreviations, contractions, or other language specific to the aviation industry. In addition, the language and structure can be different between originating sources of a NOTAM. For example, a NOTAM issued by the United States Federal Aviation Administration (FAA) can have different language and structure than a NOTAM issued by the European Organization for the Safety of Air Navigation (Eurocontrol). As such, NOTAMs can be difficult to read and contextualize. For example, the information provided in the NOTAM (such as how and where an object is affected, object identification and/or geometry, etc.) can be difficult to understand in a timely manner, particularly during flight. Furthermore, in some instances, users may review large numbers of such complex NOTAMs to plan and operate a flight, a process which can be time-consuming and prone to error.

To help contextualize aviation operation information, users reading a NOTAM may refer to a map, such as an aeronautical chart. However, current solutions to depict NOTAMs on the aeronautical chart consider the object affected (e.g., an airspace) but do not consider temporal information of the NOTAM. This can make it difficult for the user to differentiate which NOTAMs are currently affecting aviation operations and which will be affecting the aviation operations soon or intermittently. For example, if a NOTAM is not currently affecting operations and therefore not displayed, then when the NOTAM starts to currently affect operations and thereby appearing on the aeronautical chart, the user may become surprised. This may reduce an effectiveness of a pre-flight briefing. Further, NOTAMs can arrive in real time such that a user might receive a NOTAM inflight and/or just before the flight. In such instances, the NOTAM may be difficult to digest in a timely manner for the users.

Accordingly, examples are disclosed that relate to utilizing a determined status of a NOTAM to visually depict the NOTAM. Briefly, a computing device is configured to obtain a NOTAM related to an airspace, and determine a status of the NOTAM. As discussed in more detail below, the determined status can be classified as active or inactive depending on whether the NOTAM is currently in effect and/or operative. The computing device also is configured to display a graphical airspace representing the airspace and a graphic overlay for the NOTAM on the graphical airspace. Here, the graphic overlay has a first appearance when the determined status of the NOTAM is inactive and a second appearance when the determined status of the NOTAM is active. In this manner, a codified graphical representation for the NOTAM can be displayed on an aeronautical chart so that a user can locate an area affected by the NOTAM while also perceiving the current determined status of the NOTAM. Additionally, the user can also locate inactive NOTAMs that may be of interest. This can help enable the user to more quickly parse and digest which NOTAMs may affect a selected flight plan than NOTAM depictions that do not consider a status of a NOTAM.

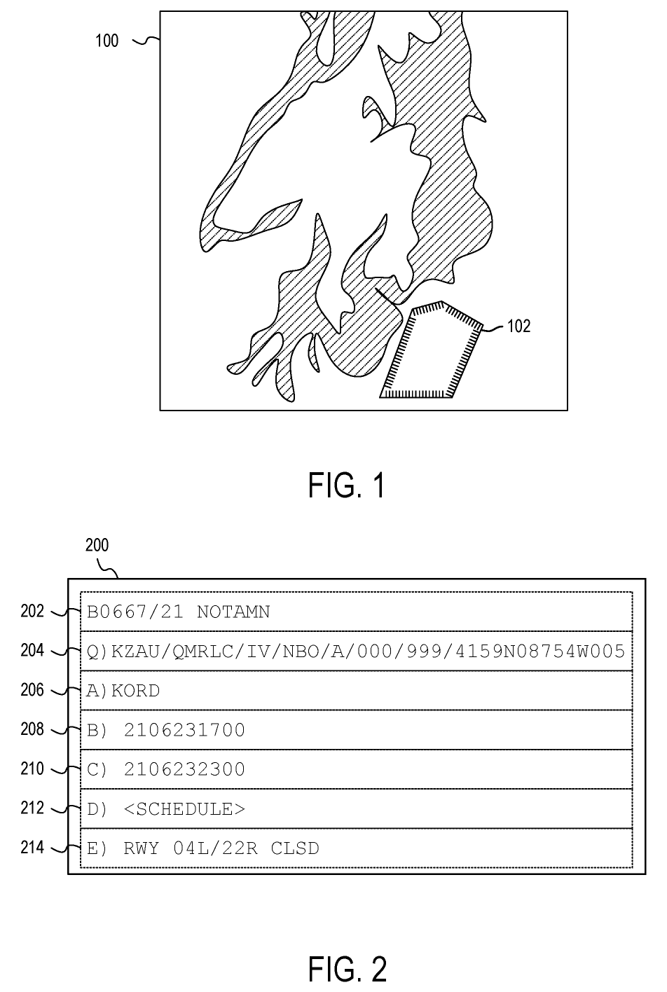

FIG. 1 schematically depicts an example aeronautical chart 100 for displaying geospatial aviation data. Aeronautical chart 100 can represent a portion of a user interface presented on a display of a computing device (e.g., a tablet device) used by a pilot. Such geospatial aviation data can be used to assist in navigation of an aircraft. For example, a pilot may be able to determine a position, a safe altitude, a desired route to a destination, navigation aids along the route, alternative landing areas (e.g., in case of an in-flight emergency), and/or other useful information such as radio frequencies and airspace boundaries when utilizing the aeronautical chart 100. As such, the aeronautical chart 100 can include graphical representations of various components in an airspace system along with the associated information. The airspace system includes airspace regions, navigation facilities, and airports associated with a corresponding area. The airspace system also includes associated information for the various components, such as, for example, services, rules, regulations, policies, procedures, personnel, and/or equipment. As a specific example, the United States National Airspace System includes airspace regions, navigation facilities, and airports of the United States.

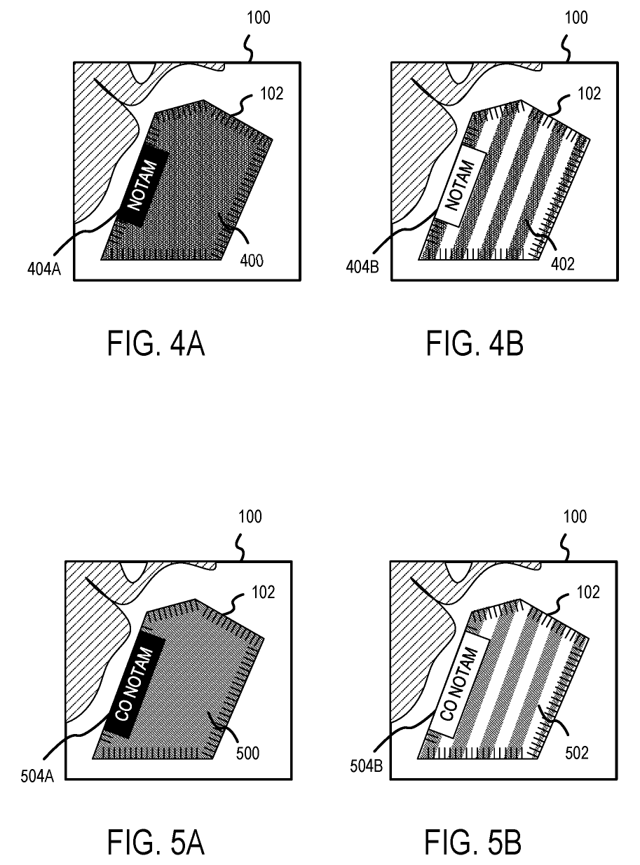

Returning to FIG. 1, the aeronautical chart 100 includes a graphical airspace 102 representing an airspace in the form of a restricted area. In other examples, another graphical airspace can have another appearance. For example, airspaces can include flight information regions (FIRs), upper information regions (UIRs), military operations areas (MOAs), special use airspaces (SUAs), and any other defined airspace types. Further, the different types of airspaces may be represented with different appearances for a corresponding graphical airspace. In some examples, a NOTAM (not depicted in FIG. 1) may be issued related to the airspace. As described in more detail below, the NOTAM can describe a condition, change, or other relevant information of the airspace. For example, a graphic overlay for the NOTAM can be displayed on the graphical airspace 102 for a visual depiction of a status of the NOTAM. Example graphic overlays are discussed with reference to FIGS. 4A, 4B, 5A, and 5B. FIG. 1 is illustrative. In other examples, an aeronautical chart may have any other suitable appearance.

As previously mentioned, a NOTAM can be issued for a component in an airspace system and describes a condition of the component. FIG. 2 schematically illustrates an example NOTAM 200. Here, the NOTAM 200 is depicted in the International Civil Aviation Organization (ICAO) NOTAM format. In other examples, a NOTAM can be in another suitable format. As depicted, the NOTAM 200 includes text information that describes a runway closure at Chicago O’Hare International Airport. Specifically, the NOTAM 200 comprises an identification line 202 for NOTAM identification, and a qualifier line 204 (“Q”) containing coded information for automated filtering of NOTAMs.

A location indicator 206 (“A”) includes the ICAO code of an aerodrome or flight information region in which a facility, airspace, or condition being reported is located. In the depicted example, the location indicator 206 comprises the text “KORD” which indicates that the NOTAM 200 is for Chicago O’Hare International Airport. Further, the NOTAM 200 comprises effective text 208 (“B”) including a start date and time in Coordinated Universal Time (UTC) format. Likewise, the NOTAM 200 also includes expiration text 210 (“C”). The effective text 208 and the expiration text 210 define when the NOTAM 200 is in effect (e.g., effectivity). In the depicted example, the NOTAM 200 has an effectivity of June 23, 2021, from 1700 to 2300 UTC. In other examples, an effectivity of a NOTAM can be for a longer duration, such as over several days.

In some examples, the NOTAM 200 can further comprise an optional schedule 212. For example, a NOTAM that has an effectivity over several days may include a schedule that indicates diurnal time where the NOTAM is operative, such as when the hours of effect are less than the 24 hours in a day. As a specific example, parachute dropping exercises may be repeated over many days and occur for a few hours during each day. In such an example, a schedule can indicate the few hours during each day when the parachute dropping exercises are operative.

A text field 214 (“E”) includes a text description of the condition in which the NOTAM 200 is being issued or put into force. Here, the text field 214 describes that runway 04L/22R is closed. In view of the above, the NOTAM 200 reports that runway 04L/22R is closed at Chicago O’Hare International airport from 1700 to 2300 UTC on June 23, 2021. FIG. 2 is illustrative. While discussed herein with reference to a runway closure, a NOTAM can describe any suitable condition for an airspace or another component in the airspace system in other examples. In further examples, a NOTAM may include other information and/or have another configuration.

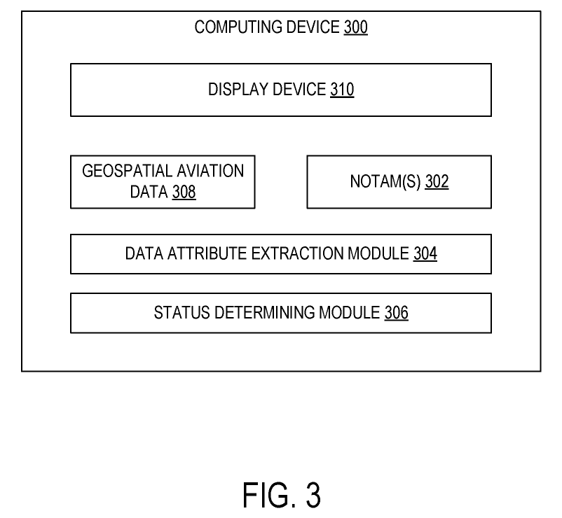

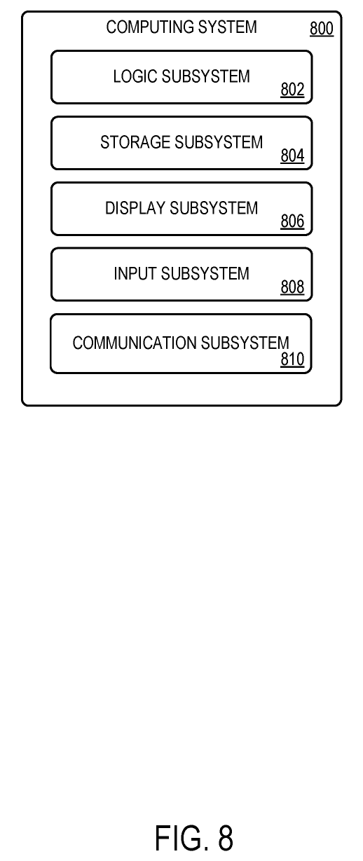

As previously discussed, the text information of a NOTAM can be difficult to digest clearly and in a timely manner. Further, current solutions to depict a NOTAM on an aeronautical chart consider the object affected, but do not consider temporal information of the NOTAM. To address such issues, a determined status of a NOTAM is utilized to display a codified graphical representation for the NOTAM. As such, FIG. 3 depicts a block diagram of an example computing device 300 configured to display a graphic overlay for a NOTAM 302. The graphic overlay has a different appearance whether a determined status of the NOTAM 302 is inactive or active. This can enable the computing device 300 to decipher and organize NOTAMs for presentation to a user. In some examples, the computing device 300 may be integrated or connected with an electronic flight bag so that the user is presented with codified graphical representations of one or more NOTAMs 302. Example hardware implementations of computing device are described below with regard to FIG. 8.

A status of the NOTAM 302 is determined based at least upon one or more data attributes extracted from the NOTAM 302. Thus, the computing device 300 includes a data attribute extraction module 304 for extracting the one or more data attributes from the NOTAM 302. The data attributes are metadata related to the text information of the NOTAM 302. For example, data attributes can be extracted from the text information of the NOTAM 200 of FIG. 2. The data attribute extraction module 304 can utilize any suitable text language analysis algorithms. In some examples, the text language analysis algorithms can include a machine learning module, such as a neural network, a decision tree, a native Bayes algorithm, a support vector machine, a principal component analysis algorithm, a k-means clustering algorithm, a generative model, a support vector machine, and/or a k-nearest neighbors (KNN) algorithm, for example. In other examples, the data attribute extraction module 304 may be omitted, and the data attributes can be extracted from the NOTAM 302 in another suitable manner.

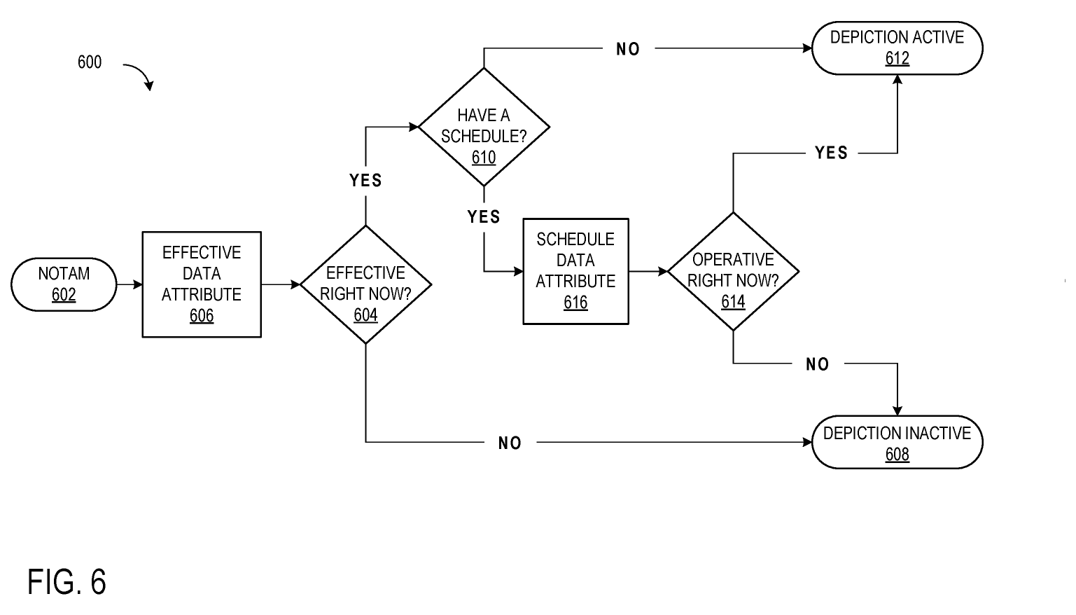

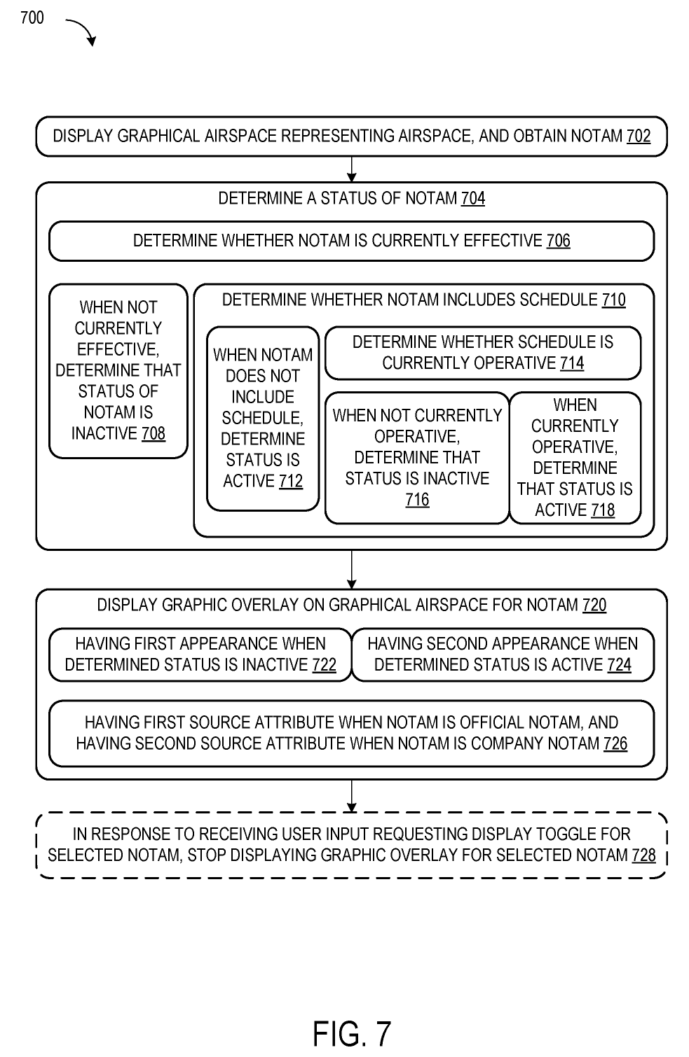

Continuing, a status determining module 306 is configured to determine the status of the NOTAM 302 based at least upon the one or more attributes extracted from the NOTAM 302. In the current example, the status determining module 306 obtains the NOTAM 302 and the extracted data attributes from the data attribute extraction module 304. More particularly, the status determining module 306 is configured to determine whether the NOTAM 302 a) is currently effective and/or b) includes a schedule. Further, when the status determining module 306 determines that the NOTAM 302 includes a schedule, the status determining module 306 can also determine whether the schedule is currently operative. Thereby, the status determining module 306 can determine a status of inactive or active based at least upon the determined effectivity and/or the determined operativity of the NOTAM 302. More detailed examples of determining a status of a NOTAM are discussed with reference to FIGS. 6 and 7.

The computing device 300 is further configured to display geospatial aviation data 308 on a display device 310. As a specific example, the computing device 300 can display selected aeronautical chart(s) on the display device 310, such as the aeronautical chart 100, for example. Thus, the graphical airspace 102 can also be displayed on the display device 310. The display device 310 can include any suitable display technology, such as a liquid crystal display panel, for example.

Further, the computing device 300 receives the NOTAM 302 related to the airspace and displays the graphic overlay on the graphical airspace on the display device 310. Specifically, the computing device 300 is configured to display the graphic overlay with a first appearance when the determined status of the NOTAM 302 is inactive, and with a second appearance when the determined status of the NOTAM 302 is active. In some examples, the graphic overlay can comprise a source attribute indicating a source of the NOTAM 302. In some such examples, a NOTAM can be issued by an aviation authority (e.g., the FAA or Eurocontrol). Such NOTAMs are referred to as “official NOTAMs” herein. In other examples, a NOTAM can be issued by an airline. Such NOTAMs are referred to herein as “company NOTAMs”. In such a manner, the computing device 300 helps to enable a user to review various NOTAMs and determine whether a selected NOTAM interferes temporally and/or geospatially with a selected flight path. In some examples, the computing device 300 can be configured to stop displaying the graphic overlay for one or more selected NOTAMs 302 in response to receiving a user input requesting a display toggle for the graphic overlay for the one or more selected NOTAMs 302. This can help the user to clear up graphic overlays for selected NOTAMs that the user does not want to be displayed on the display device 310.

As previously mentioned, a graphic overlay for a NOTAM can have a different appearance for a determined status of inactive than for a determined status of active. Further, the graphic overlay can include source attribute(s) to indicate a source of the NOTAM. FIGS. 4A, 4B, 5A, and 5B schematically depict a portion of the aeronautical chart 100 of FIG. 1 that includes the graphical airspace 102.

As previously mentioned, a NOTAM can be an official NOTAM. As such, in FIGS. 4A and 4B, example first and second graphic overlays 400, 402 for the official NOTAM are displayed on the graphical airspace 102, respectively. In such a manner, a geospatial location of the official NOTAM can be visualized within the context of the aeronautical chart 100. Here, both the first graphic overlay 400 and the second graphic overlay 402 comprise a first source attribute to indicate that a source of the official NOTAM is from an aviation authority. In the current example, the first source attribute comprises a transparent grey color and a first tag 404. As depicted, the first tag 404 includes the text “NOTAM” and is displayed attached to a border of the graphical airspace 102. In other examples, the first source attribute can have another configuration.

In FIG. 4A, the first graphic overlay 400 has an appearance for when a determined status of the official NOTAM is active. Here, the first graphic overlay 400 comprises a solid overlay having the transparent grey color of the first source attribute. Additionally, the first tag 404A is depicted with a dark color (e.g., black) with the text in a light color (e.g., white). In such a configuration, a user of the aeronautical chart 100 can visually determine that an airspace represented by the graphical airspace 102 is related to an official NOTAM that is currently active. In contrast, the second graphic overlay 402 has a different appearance for a determined status of the official NOTAM that is inactive, as depicted in FIG. 4B. Here, the second graphic overlay 402 comprises a hatched overlay having the transparent grey color. Additionally, the first tag 404B is now depicted with the light color and the text in the dark color, which is inverted from the first tag 404A. Such a configuration enables the user to spatially locate the official NOTAM even when the official NOTAM is not currently active at the time of a flight briefing. For example, it can be beneficial to review during the flight briefing NOTAMs that are currently inactive but may become active at specified temporal locations during the flight. In other examples, a graphic overlay for an official NOTAM may have another suitable appearance.

Next, in other examples a NOTAM can be a company NOTAM. In FIGS. 5A and 5B, example third and fourth graphic overlays 500, 502 for the company NOTAM are displayed on the graphical airspace 102, respectively. Here, both the third graphic overlay 500 and the fourth graphic overlay 502 comprise a second source attribute to indicate that a source of the company NOTAM is an airline. Here, the second source attribute comprises a transparent brown color and a second tag 504. As depicted, the second tag 504 includes the text “CO NOTAM” and is displayed attached to the border of the graphical airspace 102. In other examples, the second source attribute may have another configuration.

In FIG. 5A, the third graphic overlay 500 has an appearance for when a determined status of the company NOTAM is active. In a likewise manner as FIG. 4A, the third graphic overlay 500 has a solid overlay. Additionally, the second tag 504A is depicted with the dark color and the text in the light color. In contrast, the solid overlay of the third graphic overlay 500 has the transparent brown color of the second source attribute. Next, in FIG. 5B, the fourth graphic overlay 502 comprises a hatched overlay with the transparent brown color for a determined status of the company NOTAM that is inactive. Additionally, the second tag 504B is now depicted with inverted colors to the second tag 504A. This is similar in how the second graphic overlay 402 has a different appearance than the first graphic overlay 400.

In such a manner, the first, second, third, and fourth graphic overlays 400, 402, 500, 502 help to provide an easy-to-understand codification for visualizing NOTAMs with determined statuses (e.g., whether the NOTAM is active or inactive) along with geospatial context. Further, such graphic overlays do not hide information regarding potential activity of a currently inactive NOTAM, such as a NOTAM that may be temporarily inactive at a time of inspection of the aeronautical chart 100. This can help pilot Situation Awareness by reducing surprises to users compared to just depicting the currently active NOTAMs. FIGS. 4A, 4B, 5A, and 5B are illustrative. In other examples, a graphic overlay for a NOTAM may have another appearance and/or attribute.

As previously mentioned, a status of a NOTAM is determined based at least upon one or more data attributes extracted from the NOTAM. FIG. 6 illustrates a flowchart of an example method 600 for determining the status of a NOTAM. The method 600 can be performed by the status determining module 306 or another suitable module on the computing device 300. At 602, the method 600 obtains the NOTAM relating to an airspace. The NOTAM can be any suitable NOTAM including the examples disclosed herein. In various examples, the method 600 can extract data attributes from the NOTAM and/or obtain the data attributes from an extraction module, such as the data attribute extraction module 304, for example. Example data attributes include an effectivity data attribute including information regarding a period when the NOTAM is applicable, and schedule information including a timetable when the NOTAM is operative.

After obtaining the NOTAM, the method 600 determines, at 604, whether the NOTAM is currently effective based at least upon an effective data attribute 606 extracted from the NOTAM. In some examples, the method 600 can compare a current time with time information of the effective data attribute 606. When the method 600 determines that the NOTAM is not currently effective, the method 600 depicts, at 608, an inactive graphic overlay for the NOTAM. For example, the second graphic overlay 402 or the fourth graphic overlay 502 may be used for the inactive graphic overlay.

Further, when the method 600 determines that the NOTAM is currently effective, the method 600 determines, at 610, whether the NOTAM includes a schedule, such as the schedule 212, for example. When the NOTAM does not include the schedule, the method 600, at 612, depicts an active graphic overlay for the NOTAM. The active graphic overlay has a different appearance than the inactive graphic overlay. For example, the first graphic overlay 400 or the third graphic overlay 500 may be used for the active graphic overlay.

As an illustrative example, the method 600 obtains the NOTAM 200 and determines whether the NOTAM 200 is currently effective at 604. In the current NOTAM 200 example, a current time of “June 23, 2021, 1930 UTC” is used. Here, the method 600 determines that the current time is within the times of the effective text 208 (June 23, 2021, 1700 UTC) and the expiration text 210 (June 23, 2021, 2300 UTC). As such, the method 600 determines, at 610, whether the NOTAM 200 includes a schedule. Referring back to FIG. 2, it can be seen that the schedule 212 does not have text information. Therefore, the method 600 determines that the NOTAM 200 does not include a schedule and, at 612, depicts the active graphic overlay for the NOTAM 200.

Returning to FIG. 6, when the NOTAM includes a schedule, the method 600, at 614, determines whether the schedule is currently operative. In some examples, the method 600 can compare the current time to a diurnal time of a schedule data attribute 616 extracted from the NOTAM. When the method 600 determines that the schedule is currently operative, the method 600 depicts, at 612, the active graphic overlay. Conversely, when the method 600 determines that the schedule is not currently operative, the method 600 depicts, at 608, the inactive graphic overlay. FIG. 6 is illustrative. In other examples, a status of a NOTAM may be determined in another suitable manner.

FIG. 7 illustrates a flowchart of an example method 700 utilizing a determined status of a NOTAM for displaying a graphic overlay for the NOTAM. For example, the computing device 300 can perform the method 700. The NOTAM can be any suitable NOTAM, including examples discloses herein. The method 700 comprises, at 702, displaying a graphical airspace representing an airspace on a display device of the computing system, and obtaining a NOTAM related to the airspace. The method 700 further comprises, at 704, determining a status of the NOTAM. The status of the NOTAM is determined based at least upon one or more data attributes extracted from the NOTAM as will be explained.

Determining the status of the NOTAM can comprise determining whether the NOTAM is currently effective based at least upon an effective data attribute extracted from the NOTAM, as indicated at 706. When the NOTAM is determined to not be currently effective, the method 700 can comprise determining that the status of the NOTAM is inactive, as indicated at 708. In some examples, determining the status of the NOTAM further comprises determining whether the NOTAM includes a schedule, as indicated at 710. Further, in some such examples, the method 700 comprises, when the NOTAM is determined to not include the schedule, determining that the status of the NOTAM is active, as indicated at 712. In other such examples, determining whether the NOTAM includes the schedule comprises determining whether the schedule of the NOTAM is currently operative based at least upon one or more data attributes extracted from the NOTAM, as indicated at 714. Additionally, determining the status of the NOTAM comprises, when the schedule of the NOTAM is determined to not be currently operative, determining that the status of the NOTAM is inactive, as indicated at 716. Further, determining the status of the NOTAM also comprises, when the schedule of the NOTAM is determined to be currently operative, determining that the status of the NOTAM is active, as indicated at 718.

Continuing, the method 700 comprises, at 720, displaying a graphic overlay on the graphical airspace for the NOTAM. The graphic overlay has a first appearance when the determined status of the NOTAM is inactive, as indicated at 722. The graphic overlay has a second appearance when the determined status of the NOTAM is active, as indicated at 724. In some examples, the graphic overlay further comprises a source attribute indicating a source of the NOTAM. In some such examples, displaying the graphic overlay for the NOTAM comprises displaying the graphic overlay having a first source attribute when the NOTAM is an official NOTAM, and displaying the graphic overlay having a second source attribute when the NOTAM is a company NOTAM, as indicated at 726.

The method 700 further can comprise, in response to receiving a user input requesting a display toggle for the graphic overlay for a selected NOTAM, stopping to display the graphic overlay for the selected NOTAM, as indicated at 728. This enables a user to clear one or more selected NOTAMs from an aeronautical chart. In such a manner, the method 700 helps to provide a depiction for NOTAMs on an aeronautical chart independently of the source of the NOTAM, and also based at least upon a determined status of the NOTAM. Such a status is determined utilizing temporal data attributes extracted from the NOTAM (e.g., effectivity, schedule, etc.). This can help users to visualize and contextualize NOTAMs that may impact a flight path at desired temporal and geospatial locations in a timely manner.

In some embodiments, the examples described herein can be tied to a computing system of one or more computing devices. In particular, aspects of such methods and processes can be implemented as a computer-application program or service, an application-programming interface (API), a library, and/or other computer-program product.

FIG. 8 schematically shows a non-limiting embodiment of a computing system 800 that can enact one or more of the examples described above. For example, computing system 800 can be used to execute instructions to perform the method 600 of FIG. 6, the method 700 of FIG. 7, and/or potentially perform other functions.

Computing system 800 is shown in simplified form. Computing system 800 can take the form of one or more personal computers, server computers, tablet computers, network computing devices, mobile computing devices, mobile communication devices (e.g., smart phone), and/or other computing devices. In some examples, the computing device 300 of FIG. 3 can comprise one or more aspects of the computing system 800.

Computing system 800 includes a logic subsystem 802, a storage subsystem 804, and a display subsystem 806. Computing system 800 can optionally include an input subsystem 808, a communication subsystem 810, and/or other components not shown in FIG. 8.

Logic subsystem 802 includes one or more physical devices configured to execute instructions. For example, logic subsystem 802 can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result. For example, logic subsystem 802 can be used to execute instructions to perform the method 600 of FIG. 6 and/or the method 700 of FIG. 7. As a further example, logic subsystem 802 can be used to execute the data attribute extraction module 304 and/or the status determining module 306 of FIG. 3.

Logic subsystem 802 can include one or more processors configured to execute software instructions. Additionally or alternatively, logic subsystem 802 can include one or more hardware or firmware logic machines configured to execute hardware or firmware instructions. Processors of logic subsystem 802 can be single-core or multi-core, and the instructions executed thereon can be configured for sequential, parallel, and/or distributed processing. Individual components of logic subsystem 802 optionally can be distributed among two or more separate devices, which can be remotely located and/or configured for coordinated processing. Aspects of logic subsystem 802 can be virtualized and executed by remotely accessible, networked computing devices configured in a cloud-computing configuration.

Storage subsystem 804 includes one or more physical devices configured to hold instructions executable by logic subsystem 802 to implement the methods and processes described herein. For example, storage subsystem 804 can hold instructions executable to perform the method 600 of FIG. 6 and/or the method 700 of FIG. 7, and/or potentially perform other functions. As another example, the instructions can comprise the status determining module 306 and/or the data attribute extraction module 304 of FIG. 3. When such methods and processes are implemented, the state of storage subsystem 804 can be transformed—e.g., to hold different data.

Storage subsystem 804 can include removable and/or built-in devices. Storage subsystem 804 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 804 can include volatile, nonvolatile, dynamic, static, read/write, read-only, random-access, sequential-access, location-addressable, file-addressable, and/or content-addressable devices.

It will be appreciated that storage subsystem 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 802 and storage subsystem 804 can be integrated together into one or more hardware-logic components. Such hardware-logic components can include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

Display subsystem 806 can be used to present a visual representation of data held by storage subsystem 804. This visual representation can take the form of a graphical user interface (GUI). As the herein described methods and processes change the data held by the storage subsystem 804, and thus transform the state of the storage machine, the state of display subsystem 806 can likewise be transformed to visually represent changes in the underlying data. The display device 310 is an example of display subsystem 806.

Display subsystem 806 can include one or more display devices utilizing virtually any type of technology. Such display devices can be combined with logic subsystem 802 and/or storage subsystem 804 in a shared enclosure, or such display devices can be peripheral display devices.

When included, input subsystem 808 can comprise or interface with one or more user-input devices such as a keyboard, mouse, touch screen, or joystick. In some embodiments, the input subsystem 808 can comprise or interface with selected natural user input (NUI) componentry. Such componentry can be integrated or peripheral, and the transduction and/or processing of input actions can be handled on- or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. For example, input subsystem 808 can be configured to receive user inputs while performing the method 700.

When included, communication subsystem 810 can be configured to communicatively couple computing system 800 with one or more other computing devices. Communication subsystem 810 can include wired and/or wireless communication devices compatible with one or more different communication protocols. As non-limiting examples, the communication subsystem can be configured for communication via a wireless telephone network, or a wired or wireless local- or wide-area network. In some embodiments, communication subsystem 810 can allow computing system 800 to send and/or receive messages (e.g., the NOTAM 200, the NOTAMs 302, etc.) to and/or from other devices via a network such as the Internet. For example, communication subsystem 810 can be used receive or send data to another computing system.

Further, the disclosure comprises configurations according to the following clauses.

Clause 1. A computing device comprising a display device, a logic subsystem, and a memory subsystem. The memory subsystem comprises instructions executable by the logic subsystem to display a graphical airspace representing an airspace on the display device, obtain one or more notice to air missions (NOTAMs) related to the airspace, and for each NOTAM of the one or more NOTAMs, display a graphic overlay on the graphical airspace, the graphic overlay having an appearance based at least upon a determined status of the NOTAM.

Clause 2. The computing device of clause 1, wherein the instructions executable to display the graphic overlay on the graphical airspace comprise instructions executable to display the graphic overlay with a first appearance when the determined status of the NOTAM is inactive and display the graphic overlay with a second appearance when the determined status of the NOTAM is active.

Clause 3. The computing device of clause 2, wherein the first appearance of the graphic overlay comprises a hatched overlay, and wherein the second appearance of the graphic overlay comprises a solid overlay.

Clause 4. The computing device of clause 2, wherein the instructions are further executable to determine a status of the NOTAM based at least upon one or more data attributes extracted from the NOTAM.

Clause 5. The computing device of clause 1, wherein the graphic overlay further comprises a source attribute indicating a source of the NOTAM, and wherein the instructions executable to display the graphic overlay on the graphical airspace comprise instructions executable to display the graphic overlay having a first source attribute when the NOTAM is an official NOTAM, and display the graphic overlay having a second source attribute when the NOTAM is a company NOTAM.

Clause 6. The computing device of clause 5, wherein the first source attribute comprises a first tag, the second source attribute comprises a second tag, and wherein the instructions executable to display the graphic overlay comprise instructions executable to display either the first tag or the second tag attached to a border of the graphical airspace.

Clause 7. The computing device of clause 5, wherein the first source attribute comprises a first color, and the second source attribute comprises a second color.

Clause 8. The computing device of clause 1, wherein the instructions are further executable to, in response to receiving a user input requesting a display toggle for the graphic overlay for a selected NOTAM, stop displaying the graphic overlay for the selected NOTAM.

Clause 9. A method comprising displaying a graphical airspace representing an airspace on a display device, and obtaining a notice to air mission (NOTAM). The NOTAM being related to the airspace. The method further comprises determining a status of the NOTAM by determining whether the NOTAM is currently effective based at least upon an effective data attribute extracted from the NOTAM, and when the NOTAM is determined to not be currently effective, determining that the status of the NOTAM is inactive, and displaying a graphic overlay on the graphical airspace for the NOTAM. The graphic overlay has a first appearance when the determined status of the NOTAM is inactive, and has a second appearance when the determined status of the NOTAM is active.

Clause 10. The method of clause 9, wherein displaying the graphic overlay with the first appearance on the graphical airspace when the determined status of the NOTAM is inactive comprises displaying the graphic overlay with a hatched overlay, and displaying the graphic overlay with the second appearance on the graphical airspace when the determined status of the NOTAM is active comprises displaying the graphic overlay with a solid overlay.

Clause 11. The method of clause 9, wherein determining the status of the NOTAM further comprises determining whether the NOTAM includes a schedule, and when the NOTAM is determined to not include the schedule, determining that the status of the NOTAM is active.

Clause 12. The method of clause 11, wherein determining whether the NOTAM includes the schedule comprises determining whether the schedule of the NOTAM is currently operative based at least upon one or more data attributes extracted from the NOTAM, when the schedule of the NOTAM is determined to be currently operative, determining that the status of the NOTAM is active, and when the schedule of the NOTAM is determined to not be currently operative, determining that the status of the NOTAM is inactive.

Clause 13. The method of clause 9, wherein the graphic overlay further comprises a source attribute indicating a source of the NOTAM, and wherein displaying the graphic overlay for the NOTAM comprises displaying the graphic overlay having a first source attribute when the NOTAM is an official NOTAM, and displaying the graphic overlay having a second source attribute when the NOTAM is a company NOTAM.

Clause 14. The method of clause 9, further comprising, in response to receiving a user input requesting a display toggle for the graphic overlay for a selected NOTAM, stopping to display the graphic overlay for the selected NOTAM.

Clause 15. A computing device comprising a display device, a logic subsystem, and a memory subsystem comprising instructions executable by the logic subsystem. The instructions are executable to display a graphical airspace representing an airspace on the display device, and obtain a notice to air mission (NOTAM). The NOTAM is related to the airspace. The instructions are further executable to determine a status of the NOTAM by determining whether the NOTAM is currently effective based at least upon an effective data attribute extracted from the NOTAM, and when the NOTAM is determined to not be currently effective, determining that the status of the NOTAM is inactive, and display a graphic overlay on the graphical airspace for the NOTAM. The graphic overlay has a first appearance when the determined status of the NOTAM is inactive, and has a second appearance when the determined status of the NOTAM is active.

Clause 16. The computing device of clause 15, wherein the instructions executable to determine the status of the NOTAM are further executable to determine whether the NOTAM includes a schedule, and when the NOTAM is determined to not include the schedule, determine that the status of the NOTAM is active.

Clause 17. The computing device of clause 16, wherein the instructions executable to determine whether the NOTAM includes the schedule comprise instructions executable to determine whether the schedule of the NOTAM is currently operative based at least upon one or more data attributes extracted from the NOTAM, when the schedule of the NOTAM is determined to be currently operative, determine that the status of the NOTAM is active, and when the schedule of the NOTAM is determined to not be currently operative, determine that the status of the NOTAM is inactive.

Clause 18. The computing device of clause 15, wherein the graphic overlay further comprises a source attribute indicating a source of the NOTAM, and wherein the instructions executable to display the graphic overlay on the graphical airspace comprise instructions executable to display the graphic overlay having a first source attribute when the NOTAM is an official NOTAM, and display the graphic overlay having a second source attribute when the NOTAM is a company NOTAM.

Clause 19. The computing device of clause 18, wherein the first source attribute comprises a first tag, and the second source attribute comprises a second tag, and wherein the instructions executable to display the graphic overlay comprise instructions executable to display either the first tag or the second tag attached to a border of the graphical airspace.

Clause 20. The computing device of clause 18, wherein the first source attribute comprises a first color, and the second source attribute comprises a second color.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a display device;
a logic subsystem; and
a memory subsystem comprising instructions executable by the logic subsystem to
display a graphical airspace representing an airspace on the display device,
obtain one or more notice to air missions (NOTAMs) related to the airspace, and
for each NOTAM of the one or more NOTAMs, display a graphic overlay on the graphical airspace, the graphic overlay having an appearance based at least upon a determined status of the NOTAM.

2. The computing device of claim 1, wherein the instructions executable to display the graphic overlay on the graphical airspace comprise instructions executable to display the graphic overlay with a first appearance when the determined status of the NOTAM is inactive and display the graphic overlay with a second appearance when the determined status of the NOTAM is active.

3. The computing device of claim 2, wherein the first appearance of the graphic overlay comprises a hatched overlay, and wherein the second appearance of the graphic overlay comprises a solid overlay.

4. The computing device of claim 2, wherein the instructions are further executable to determine a status of the NOTAM based at least upon one or more data attributes extracted from the NOTAM.

5. The computing device of claim 1, wherein the graphic overlay further comprises a source attribute indicating a source of the NOTAM, and wherein the instructions executable to display the graphic overlay on the graphical airspace comprise instructions executable to
display the graphic overlay having a first source attribute when the NOTAM is an official NOTAM, and
display the graphic overlay having a second source attribute when the NOTAM is a company NOTAM.

6. The computing device of claim 5, wherein the first source attribute comprises a first tag, the second source attribute comprises a second tag, and wherein the instructions executable to display the graphic overlay comprise instructions executable to display either the first tag or the second tag attached to a border of the graphical airspace.

7. The computing device of claim 5, wherein the first source attribute comprises a first color, and the second source attribute comprises a second color.

8. The computing device of claim 1, wherein the instructions are further executable to, in response to receiving a user input requesting a display toggle for the graphic overlay for a selected NOTAM, stop displaying the graphic overlay for the selected NOTAM.

9. A method comprising:
displaying a graphical airspace representing an airspace on a display device, and obtaining a notice to air mission (NOTAM), the NOTAM being related to the airspace;
determining a status of the NOTAM by
determining whether the NOTAM is currently effective based at least upon an effective data attribute extracted from the NOTAM, and
when the NOTAM is determined to not be currently effective, determining that the status of the NOTAM is inactive; and
displaying a graphic overlay on the graphical airspace for the NOTAM, the graphic overlay having a first appearance when the determined status of the NOTAM is inactive, and having a second appearance when the determined status of the NOTAM is active.

10. The method of claim 9, wherein displaying the graphic overlay with the first appearance on the graphical airspace when the determined status of the NOTAM is inactive comprises displaying the graphic overlay with a hatched overlay, and displaying the graphic overlay with the second appearance on the graphical airspace when the determined status of the NOTAM is active comprises displaying the graphic overlay with a solid overlay.

11. The method of claim 9, wherein determining the status of the NOTAM further comprises determining whether the NOTAM includes a schedule, and when the NOTAM is determined to not include the schedule, determining that the status of the NOTAM is active.

12. The method of claim 11, wherein determining whether the NOTAM includes the schedule comprises determining whether the schedule of the NOTAM is currently operative based at least upon one or more data attributes extracted from the NOTAM,
when the schedule of the NOTAM is determined to be currently operative, determining that the status of the NOTAM is active, and
when the schedule of the NOTAM is determined to not be currently operative, determining that the status of the NOTAM is inactive.

13. The method of claim 9, wherein the graphic overlay further comprises a source attribute indicating a source of the NOTAM, and wherein displaying the graphic overlay for the NOTAM comprises
displaying the graphic overlay having a first source attribute when the NOTAM is an official NOTAM, and
displaying the graphic overlay having a second source attribute when the NOTAM is a company NOTAM.

14. The method of claim 9, further comprising, in response to receiving a user input requesting a display toggle for the graphic overlay for a selected NOTAM, stopping to display the graphic overlay for the selected NOTAM.

15. A computing device comprising:
a display device;
a logic subsystem; and
a memory subsystem comprising instructions executable by the logic subsystem to
display a graphical airspace representing an airspace on the display device, and obtain a notice to air mission (NOTAM), the NOTAM being related to the airspace,
determine a status of the NOTAM by
determining whether the NOTAM is currently effective based at least upon an effective data attribute extracted from the NOTAM, and
when the NOTAM is determined to not be currently effective, determining that the status of the NOTAM is inactive, and
display a graphic overlay on the graphical airspace for the NOTAM, the graphic overlay having a first appearance when the determined status of the NOTAM is inactive, and having a second appearance when the determined status of the NOTAM is active.

16. The computing device of claim 15, wherein the instructions executable to determine the status of the NOTAM are further executable to determine whether the NOTAM includes a schedule, and when the NOTAM is determined to not include the schedule, determine that the status of the NOTAM is active.

17. The computing device of claim 16, wherein the instructions executable to determine whether the NOTAM includes the schedule comprise instructions executable to determine whether the schedule of the NOTAM is currently operative based at least upon one or more data attributes extracted from the NOTAM,
when the schedule of the NOTAM is determined to be currently operative, determine that the status of the NOTAM is active, and
when the schedule of the NOTAM is determined to not be currently operative, determine that the status of the NOTAM is inactive.

18. The computing device of claim 15, wherein the graphic overlay further comprises a source attribute indicating a source of the NOTAM, and wherein the instructions executable to display the graphic overlay on the graphical airspace comprise instructions executable to
display the graphic overlay having a first source attribute when the NOTAM is an official NOTAM, and
display the graphic overlay having a second source attribute when the NOTAM is a company NOTAM.

19. The computing device of claim 18, wherein the first source attribute comprises a first tag, and the second source attribute comprises a second tag, and wherein the instructions executable to display the graphic overlay comprise instructions executable to display either the first tag or the second tag attached to a border of the graphical airspace.

20. The computing device of claim 18, wherein the first source attribute comprises a first color, and the second source attribute comprises a second color.
